(19) United States
(12) Patent Application Publication
(10) Pub. No.: US 2015/0071781 A1
(43) Pub. Date: Mar. 12, 2015

(54) CENTRIFUGAL FAN AND AIR-CONDITIONING APPARATUS

(71) Applicant: Mitsubishi Electric Corporation, Tokyo (JP)

(72) Inventors: Makoto KURIHARA, Tokyo (JP); Kohei TSUNETOMO, Tokyo (JP); Masahiko TAKAGI, Tokyo (JP)

(21) Appl. No.: 14/471,046

(22) Filed: Aug. 28, 2014

(30) Foreign Application Priority Data
Sep. 12, 2013 (JP) 2013-189719

(51) Int. Cl. F01D 25/06; F04D 17/10; F01D 5/22

(52) U.S. Cl. CPC F01D 25/06; F01D 5/225; F04D 17/10; F05D 2260/96
USPC 416/186 R

(57) ABSTRACT

A centrifugal fan includes a main plate fixed to a rotating shaft of a drive unit, a shroud having an air suction port, and a plurality of blades disposed between the main plate and the shroud. A rib for reinforcement is formed in each of the blades. Deformation due to an external pressure can be suppressed, the main plate, the shroud, and the blades are firmly fixed to each other, and a decrease in reliability, generation of noise, and the like due to deformation are suppressed.

### TECHNICAL FIELD

The present invention relates to a centrifugal fan or the like that draws a gas by suction in the direction of the axis of rotation and blows out the gas in directions intersecting the axis of rotation.

### BACKGROUND ART

For example, an impeller used in a centrifugal fan has mainly employed two-dimensional blades not having a twisted shape between a main plate and a shroud. For this reason, in general, a main plate and blades can be integrally molded using, for example, a resin. However, in order to achieve further noise reduction, power consumption reduction, and the like, for example, a centrifugal fan is required whose blades disposed between a main plate and a shroud are, for example, three-dimensional blades.

When a centrifugal fan (impeller) has three-dimensional blades, in order to improve the degree of freedom of resin molding, the impeller (particularly each blade) is often manufactured by, for example, separately molding a plurality of components, assembling the plurality of molded components, and fixing them by joining or the like. By dividing the impeller into a plurality of components, blades or the like having a complex shape can be obtained. If blades have a hollow structure in this case, a lightweight arrangement can be achieved (see, for example, Patent Literature 1).

For example, in the fitting parts of a plurality of components forming a three-dimensional blade of an axial fan, the assembled components are fitted to each other, fitting lines formed between the components are bent in a zigzag manner, spot ultrasonic joining is performed at the bending points, and the number of joints is thereby increased to improve the joining strength (see, for example, Patent Literature 2).

### CITATION LIST

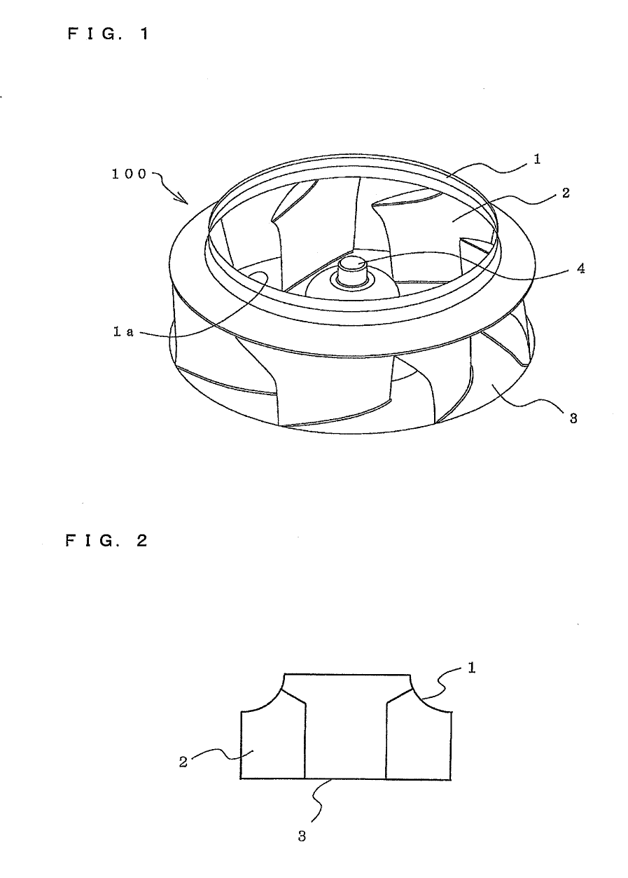

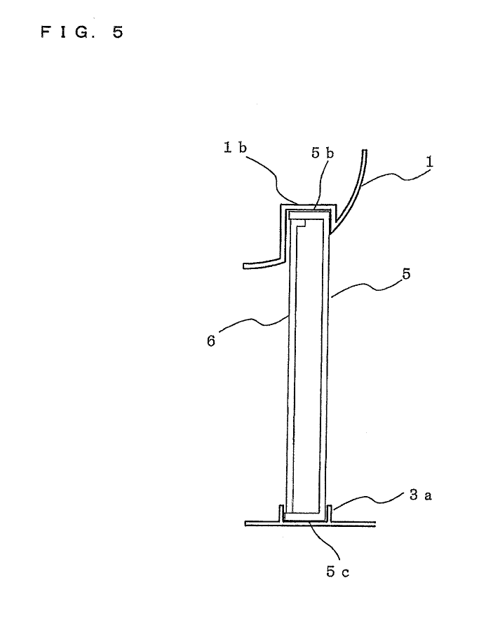

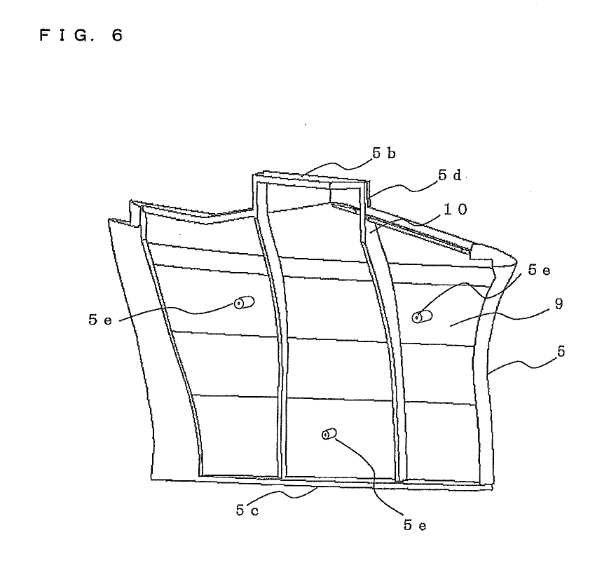

### Patent Literature

[Patent Literature 1] Japanese Patent No. 4432474 (FIGS. 5 & 6)

[Patent Literature 2] Japanese Unexamined Patent Application Publication No. 10-122196 (FIG. 1)

### SUMMARY OF INVENTION

### Technical Problem

As described above, an impeller part of a centrifugal fan is manufactured by dividing it into a plurality of components (for example, a main plate, a shroud, and blades), and then the components are fixed to each other by joining or the like. For example, the blades disposed between the main plate and the shroud are welded to the main plate and the shroud by irradiation with laser light, application of ultrasonic vibration, or the like. During welding, a pressure is applied between the blades and the main plate, and between the blades and the shroud, and the welding surfaces are pressed against and brought into close contact with each other so as to be joined firmly.

For example, particularly when the blades have a hollow structure, the blades may significantly deform depending on an external pressure. For example, if the blades significantly deform during welding, breakage, failure in joining due to decreased closeness of contact of welding surfaces, or the like may occur, leading to a decrease in reliability, generation of noise, and the like.

The present invention has been made to solve the above problem, and has as its object to obtain a centrifugal fan or the like resistant to an external pressure.

### Solution to Problem

A centrifugal fan according to the present invention includes a main plate fixed to a rotating shaft of a drive unit, a shroud having an air suction port, and a plurality of blades disposed between the main plate and the shroud. A rib is formed in the hollow structure of each of the blades.

### Advantageous Effects of Invention

With the centrifugal fan according to the present invention, a rib is provided in each of the blades. Therefore, deformation of the blades due to an external pressure can be suppressed, and a decrease in reliability, generation of noise, and the like due to deformation can be suppressed.

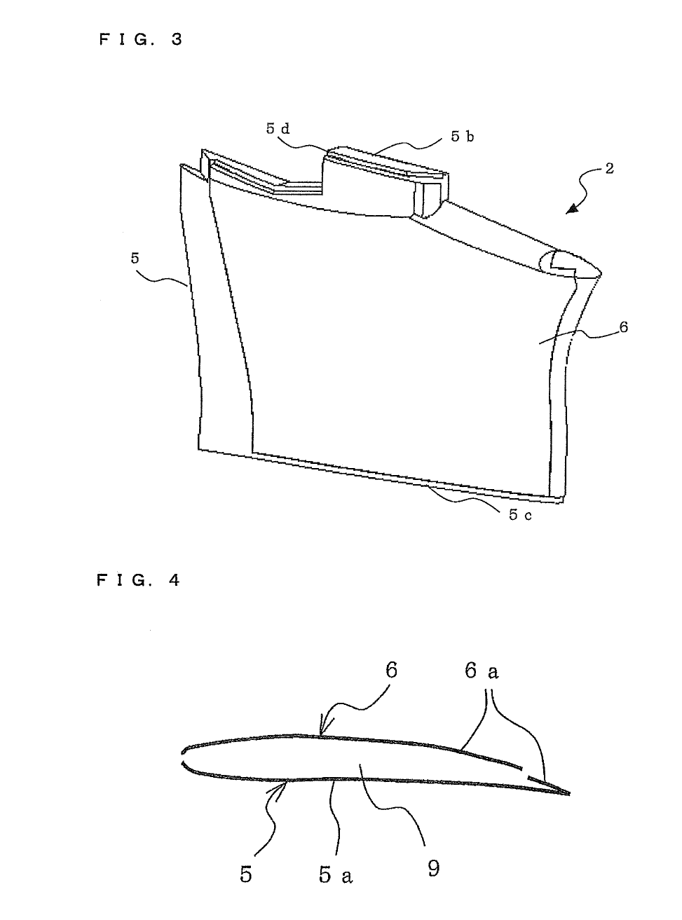

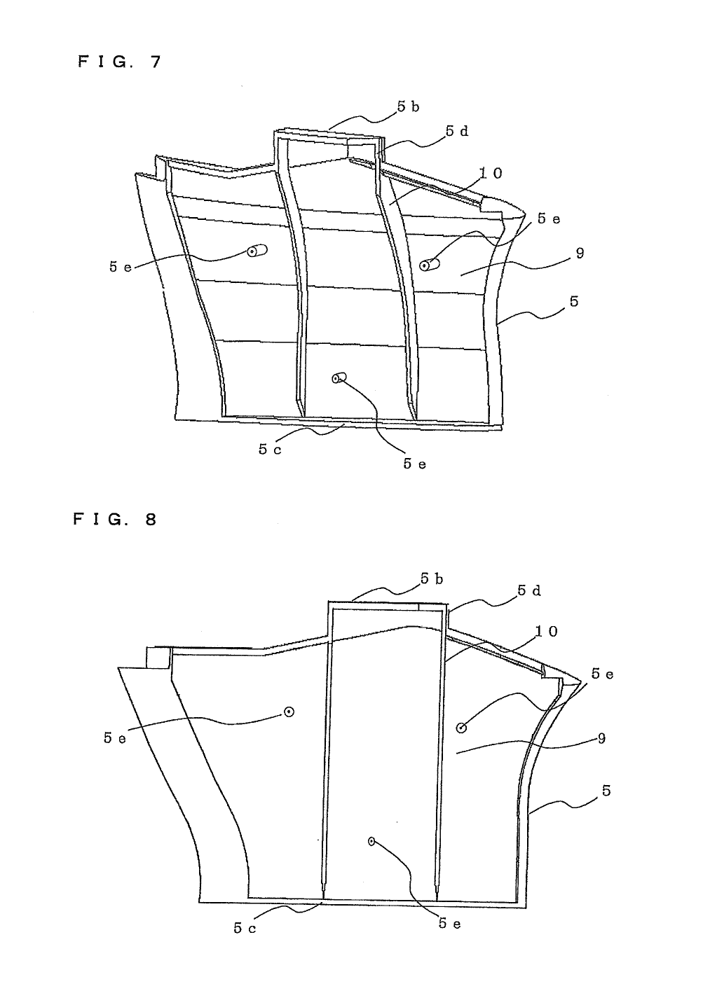

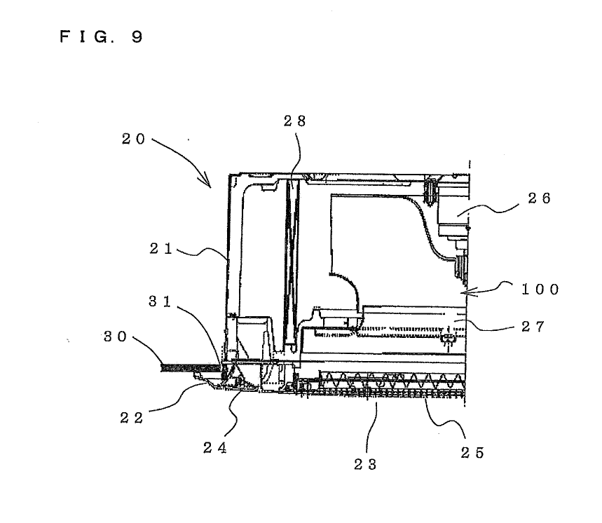

### BRIEF DESCRIPTION OF DRAWINGS

[FIG. 1] FIG. 1 is a perspective view showing the configuration of a centrifugal fan according to Embodiment 1 of the present invention.

[FIG. 2] FIG. 2 is a diagram showing the schematic configuration of a cross-section of an impeller of the centrifugal fan according to Embodiment 1 of the present invention.

[FIG. 3] FIG. 3 is a perspective view showing the configuration of a blade of the centrifugal fan according to Embodiment 1 of the present invention.

[FIG. 4] FIG. 4 is a sectional view showing the configuration of the blade of the centrifugal fan according to Embodiment 1 of the present invention as viewed from the side.

[FIG. 5] FIG. 5 is a diagram showing the schematic configuration of the impeller of the centrifugal fan according to Embodiment 1 of the present invention as viewed from the front of the blade.

[FIG. 6] FIG. 6 is a perspective view showing the configuration of a main blade of the centrifugal fan according to Embodiment 1 of the present invention.

[FIG. 7] FIG. 7 is a perspective view showing the configuration of a main blade of a centrifugal fan according to Embodiment 2 of the present invention.

[FIG. 8] FIG. 8 is a perspective view showing the configuration of a main blade of a centrifugal fan according to Embodiment 3 of the present invention.

[FIG. 9] FIG. 9 shows an air-conditioning apparatus according to Embodiment 5 of the present invention.

### DESCRIPTION OF EMBODIMENTS

Centrifugal fans and the like according to embodiments of the present invention will now be described with reference to the accompanying drawings and the like. In the accompanying drawings, the same reference numerals denote the same or equivalent components, and are common throughout embodiments to be described below. The forms of components described in the specification in its entirety are merely illustrative, and the present invention is not limited to the forms described in the specification. In particular, combinations of components are not limited to those in each embodiment, and components described in one embodiment can be applied to another embodiment. Also in the drawings, the relationship in size between components is often different from the actual one.

### Embodiment 1

FIG. 1 is a perspective view showing the configuration of a centrifugal fan according to Embodiment 1 of the present invention. FIG. 2 is a diagram showing the schematic configuration of a cross-section of an impeller of the centrifugal fan according to Embodiment 1 of the present invention, The impeller 100 of the centrifugal fan according to Embodiment 1 is provided with a plurality of blades 2 (seven blades 2 in FIG. 1) between a shroud 1 and a main plate 3, as shown in FIGS. 1 and 2.

The shroud 1 has a bell mouth shape and includes an air suction port 1a. The blades 2 of Embodiment 1 are three-dimensional blades having a twisted shape between the shroud 1 and the main plate 3. Therefore, noise reduction, power consumption reduction, and the like can be achieved. A boss 4 serving as a rotating shaft is attached to the center of the main plate 3. A drive unit (a fan motor or the like) is attached to the boss 4, and rotates the impeller 100. Upon rotation, the impeller 100 draws a gas (for example, air) by suction in the direction of the axis of rotation and blows out the drawn gas in outer peripheral directions intersecting the axis of rotation. The shroud 1, the blades 2, and the main plate 3 are made of a resin. The details of the shroud 1, the blades 2, and the main plate 3 will be described later.

FIG. 3 is a perspective view showing the configuration of a blade of the centrifugal fan according to Embodiment 1 of the present invention. FIG. 4 is a sectional view showing the configuration of the blade of the centrifugal fan according to Embodiment 1 of the present invention as viewed from the side (in a direction almost perpendicular to that in which the blade cuts through air). As shown in FIGS. 3 and 4, in Embodiment 1, a blade 2 is fabricated by assembling a plurality of components (a main blade 5 and a blade cover 6). In assembling, the main blade 5 and the blade cover 6 may be fixed to each other only by fitting. In this case, for example, a protruding portion (not shown) on the surface, facing a hollow portion 9, of the blade cover 6 is fitted into and fixed to a boss 5e (see FIG. 6; to be described later) on the surface, facing the hollow portion 9, of the main blade 5. Depending on circumstances involved, in addition, joining and fixing may be performed by bonding, welding, or the like. In Embodiment 1, in the blade 2, the main blade 5 forms the whole of a suction surface 5a and a part o a pressure surface 6a. Also, the blade cover 6 forms the rest of the pressure surface 6a, which is not formed by the main blade 5. Note that the relationship between the pressure surface 6a and the suction surface 5a formed by the main blade 5 and the blade cover 6 is not limited to this. Although, in Embodiment 1, each blade 2 is fabricated by assembling two components, namely, the main blade 5 and the blade cover 6, the number of components is not limited. Each blade 2 may be fabricated by assembling three or more components in conformity to its shape. By assembling the main blade 5 and the blade cover 6, a space serving as the hollow portion 9 is formed between the main blade 5 and the blade cover 6. By making the blades 2 hollow, a lightweight arrangement of the impeller 100, low material costs, and the like can be achieved.

FIG. 5 is a diagram showing the schematic configuration of a cross-section of the impeller of the centrifugal fan according to Embodiment 1 of the present invention as viewed from the front of a blade (in the direction in which the blade cuts through air). As shown in FIGS. 3 and 5, the main blade 5 has a shroud-side side surface 5b that comes into contact with the shroud 1 and serves as a welding surface and a main-plate-side side surface 5c that comes into contact with the main plate 3 and serves as a welding surface. The blade 2 formed by assembling the main blade 5 and the blade cover 6 is placed between the shroud 1 and the main plate 3.

Since the shroud 1 has a shape with a curved surface, it is difficult to perform positioning or the like for the shroud 1 relative to the blade 2 (main blade 5). So, a protruding portion 5d whose top surface serves as a welding surface (contact surface) to be welded to the shroud 1 is formed on the shroud-side side surface 5b of the main blade 5 (blade 2), and a recessed portion 1b is formed in the shroud 1 so that the protruding portion 5d and the recess 1b can be fitted together. Therefore, the shroud 1 and the blades 2 can easily, reliably be positioned and welded. On the other hand, the main plate 3 has a recessed portion 3a. By placing the main-plate-side side surface 5c on the bottom surface portion of the recessed portion 3a, the main plate 3 and the blades 2 can easily, reliably be positioned and welded. By irradiation with laser light, application of ultrasonic vibration, or the like, the contact surface, such as the top surface of the protruding portion 5d, of the shroud-side side surface 5b of the main blade 5 (blade 2) is heated and welded to the shroud 1, The main-plate-side side surface 5c is heated and welded to the main plate 3.

Thus, the shroud 1 and the main plate 3 are joined to the main blade 5 by welding to fix the blade 2. In welding, the shroud 1 and the blade 2 are pressurized so that the shroud-side side surface 5b and the main-plate-side side surface 5c come into close contact with the shroud 1 and the main plate 3. The main plate 3 and the blade 2 are also pressurized. Since the blade 2 has the hollow portion 9 as an internal construction, for example, breakage may occur due to a pressure. For example, owing to deformation or the like of the blade 2, the shroud 1 and the blade 2, and the main plate 3 and the blade 2 may not be brought into close contact with each other. So, it is necessary to take measures so that the blade 2 is not broken by such an external pressure.

FIG. 6 is a perspective view showing the configuration of the main blade of the centrifugal fan according to Embodiment 1 of the present invention. In Embodiment 1, the main blade 5 is provided with ribs 10 for reinforcement so that the blade 2 has a rigidity sufficient to withstand an external pressure (particularly during welding). The ribs 10 are formed across the entire length between the shroud-side side surface 5b and the main-plate-side side surface 5c. Since the blade 2 is a three-dimensional blade, the ribs 10 are provided in the hollow portion 9 in Embodiment 1. By providing the ribs 10 in the hollow portion 9, the shroud-side side surface 5b and the main-plate-side side surface 5c can be supported from the inside. In addition, the flow of air is not affected.

The ribs 10 must not hamper the assembly of the main blade 5 and the blade cover 6. Therefore, the height of the ribs 10 (their height from the surface, on the back side of the suction surface 5a, of the main blade 5) preferably conform to at least the shape of a portion (the inner wall surface) facing the hollow portion 9 of the blade cover 6.

As described above, the main blade 5 is made of a resin. For example, if ribs 10 are formed on the surface, on the back side of the welding surface (contact surface), of the shroud-side side surface 5b or the like, shrinkage after molding is significant, and sink marks (depressions generated due to shrinkage) may be generated. So, in Embodiment 1, ribs 10 are formed so as to be continuous with the side wall surfaces of the protruding portion 5d. Therefore, no sink marks are generated in the welding surface of the shroud-side side surface 5b welded to the shroud 1, and therefore the closeness of contact can be maintained.

As described above, in the centrifugal fan according to Embodiment 1, the blades 2 of the impeller 100 are provided with ribs 10, and therefore the deformation of the blades 2 due to an external pressure can be suppressed, and breakage, and failure in close contact between the shroud 1 and the main plate 3 can be suppressed. Therefore, the reliability can be maintained (a decrease in reliability due to deformation can be suppressed). In addition, the blades 2 can be firmly fixed to the shroud 1 and the main plate 3, and generation of noise can be suppressed. Since the ribs 10 extend across the length from the shroud-side side surface 5b to the main-plate-side side surface 5c, the ribs function effectively against the pressure acting during welding. In Embodiment 1, the ribs 10 are formed in the hollow portion 9, and therefore can be supported at positions close to the welding surface (contact surface). When the centrifugal fan is driven, the ribs do not obstruct the flow of air. For example, by forming ribs 10 (particularly in the height direction) such that they conform to the shape of the blade cover 6, the main blade 5 and the blade cover 6 can be prevented from deforming toward the hollow portion 9. Since the blades 2 have a hollow portion 9 (hollow structure) as an internal construction, a lightweight arrangement can be achieved.

For example, since a protruding portion 5d is formed on the shroud-side side surface 5b of the main blade 5 so as to be fitted in the recessed portion 1b of the shroud 1, the positioning of the shroud 1 and the blade 2 is facilitated, and joining by, for example, welding can be performed firmly. Since the ribs 10 are formed so as to be continuous with the side wall surfaces of the protruding portion 5d so that no sink marks are generated on the back side of the welding surface (contact surface), the closeness of contact of the welding surface can be improved.

### Embodiment 2

FIG. 7 is a perspective view showing the configuration of a main blade of a centrifugal fan according to Embodiment 2 of the present invention. In FIG. 7, the same reference numerals as in FIG. 6 denote members having the same functions as those described in Embodiment 1. For example, in Embodiment 1, ribs 10 are provided for reinforcement so that blades 2 can withstand an external pressure (particularly during welding). The ribs 10 increase the weight of the blade 2 and, in turn, that of the impeller 100. Therefore, the ribs 10 are preferably as light in weight as possible, To attain this, in the impeller 100 of the centrifugal fan of Embodiment 2, a lightweight arrangement of the impeller 100 is achieved by varying the height of the ribs 10 (particularly by forming them to be partially low) while securing the function of ribs 10.

As described in Embodiment 1, if ribs 10 are provided on the back side of the welding surface, sink marks may be generated. Since the main-plate-side side surface 5c is in its entirety in contact with the main plate 3, ribs 10 need to be formed directly on the back side of the main-plate-side side surface 5c. For this reason, referring to FIG. 7, in particular, the ribs 10 on the back side of the main-plate-side side surface 5c are formed low. By making the areas of the ribs 10 formed on the back side of the main-plate-side side surface 5c as small as possible, a lightweight arrangement is achieved, sink marks generated during welding are kept small in size, and the closeness of contact between the blade 2 (main blade 5) and the main plate 3 is maintained.

As described above, in the impeller 100 of the centrifugal fan of Embodiment 2, a lightweight arrangement of the impeller 100 can be achieved by varying the height of the ribs 10 formed in the hollow portion 9 of the blade 2.

The amount of material used can be kept small to achieve low costs, In particular, by forming low portions of the ribs 10 on the back side of the main-plate-side side surface 5c that comes into contact with the main plate 3, and making the areas of contact between the main plate 3 and the ribs 10 small so that sink marks generated during welding are kept small in size, the closeness of contact between the blade 2 (main blade 5) and the main plate 3 is maintained, and therefore a highly reliable low-noise impeller 100 can be obtained.

### Embodiment 3

FIG. 8 is a perspective view showing the configuration of a main blade of a centrifugal fan according to Embodiment 3 of the present invention. In FIG. 8, the same reference numerals as in FIG. 6 denote members having the same functions as those described in Embodiment 1. In Embodiment 2, a lightweight arrangement is achieved by varying the height of ribs 10. In particular, the areas of the ribs 10 formed on the back side of the man-plate-side side surface 5c are made as small as possible so that sink marks generated during welding are kept small in size.

In the impeller 100 of the centrifugal fan of Embodiment 2, a lightweight arrangement of the impeller 100 is achieved by varying the thickness of the ribs 10 (particularly by forming them to be partially thin) while securing the function of ribs 10. For example, as shown in FIG. 8, by making the thickness of ribs 10 on the back side of the main-plate-side side surface 5c small, and making the areas of the ribs 10 as small as possible, a lightweight arrangement is achieved, sink marks generated during welding are kept small in size, and the closeness of contact between the blade 2 (main blade 5) and the main plate 3 is maintained.

As described above, in the impeller 100 of the centrifugal fan of Embodiment 3, a lightweight arrangement of the impeller 100 can be achieved by varying the thickness of the ribs 10 formed in the hollow portion 9 of the blade 2. The material used can be reduced, and cost reduction can be achieved. In particular, by forming thin portions of the ribs 10 on the back side of the main-plate-side side surface 5c that comes into contact with the main plate 3, and making the areas of contact between the main plate 3 and the ribs 10 small so that sink marks generated during welding are kept small in size, the closeness of contact between the blade 2 (main blade 5) and the main plate 3 is maintained, and therefore a highly reliable low-noise impeller 100 can be obtained.

### Embodiment 4

In Embodiment 1, the main blade 5 forms the whole of the suction surface 5a and a part of the pressure surface 6a, and the blade cover 6 forms the rest of the pressure surface 6a. However, the present invention is not limited to this. The blade cover 6 may be located on the suction surface side.

In Embodiment 2, the height of the ribs 10 is varied. In Embodiment 3, the thickness of the ribs 10 is varied. However, the present invention is not limited to either of them. Both the height and thickness of the ribs 10 may be varied.

The blades 2 in Embodiments 1 to 3 are three-dimensional blades. However, the present invention is not limited to this, and can also be applied to two-dimensional blades (particularly those having a hollow structure).

Although, in Embodiments 1 to 3, joining by welding has been described, the present invention is not limited to this, and can also be applied, for example, to a case where the shroud 1 and the main plate 3 are bonded to the blades 2 by pressurization.

Although, in Embodiments 1 to 3, ribs 10 are formed in two portions in the hollow portion 9, the present invention does not limit the number of ribs, where to form ribs, and the like. However, in terms of attaining a lightweight arrangement, the number of ribs 10 formed is preferably small.

### Embodiment 5

FIG. 9 is a diagram showing an air-conditioning apparatus according to Embodiment 5 of the present invention. FIG. 9 is a partial sectional view showing the configuration of a ceiling-embedded indoor unit of the air-conditioning apparatus. In FIG. 9, the same reference numerals denote the same devices as those described in, for example, Embodiment 1.

The ceiling-embedded indoor unit 20 according to Embodiment 5 is embedded in a ceiling 30, and a lower surface opening is open from an opening 31 of the ceiling 30. From the lower surface opening of a body shell 21 to the periphery of the opening 31 of the ceiling 30, a decorative panel 22 having an air inlet 23 and an air outlet 24 is attached. A filter 25 is disposed on the downstream side of the air inlet 23.

A fan motor 26 serving as a drive unit is attached to a top plate of the body shell 21. The boss 4 of the impeller 100 of the centrifugal fan disposed so that the air suction port 1a of the shroud 1 faces the air inlet 23 of the decorative panel 22 is fixed to the output shaft of the fan motor 26. A bell mouth 27 is placed between the air inlet 23 of the decorative panel 22 and the air suction port 1a of the shroud 1 of the impeller 100 of the centrifugal fan. A heat exchanger 28 is placed in an air passage leading from the air inlet 23 to the air outlet 24 and on the outer periphery of the impeller 100 of the centrifugal fan on the downstream side.

In the air-conditioning apparatus having the above-described ceiling-embedded indoor unit 20, when its operation starts, the fan motor 26 of the centrifugal fan is rotated, and the impeller 100 fixed to it rotates. Indoor air is drawn by suction upon the rotation of the impeller 100 through the air inlet 23, is cleaned by the filter 25, flows into the impeller 100 through the hell mouth 27, and flows out of the impeller 100 through the gaps between the blades 2 toward its outer periphery. The air flowing out of the impeller 100 passes through the heat exchanger 28, turns into cold or hot conditioned air, and is blown out through the air outlet 24 into the room.

Since the air-conditioning apparatus of Embodiment 5 has a centrifugal an employing the centrifugal fan impeller 100 described in each of Embodiments 1 to 4, a high-strength, low-noise, and energy-saving air-conditioning apparatus can be obtained.

The above description assumes that a centrifugal fan according to the present invention is employed in the indoor unit (see FIG. 9) of an air-conditioning apparatus. However, the present invention is not limited to this. A centrifugal fan according to the present invention can be employed in an indoor unit having another structure. A centrifugal fan according to the present invention can also be employed in an outdoor unit of an air-conditioning apparatus, an air cleaner, and the like.

### REFERENCE SIGNS LIST

1: shroud, 1a: air suction port. 1b: recessed portion, 2: blade. 3: main plate, 3a: recessed portion, 4: boss, 5: main blade, 5a: suction surface, 5b: shroud-side side surface, 5c: main-plate-side side surface, 5d: protruding portion, 5e: boss, 6: blade cover, 6a: pressure surface, 9: hollow portion, 10: rib, 20: indoor unit, 21: body shell, 22: decorative panel, 23: air inlet, 24: air outlet, 25: filter, 26: fan motor, 27: bell mouth, 28: heat exchanger, 30: ceiling, 31: opening, 100: impeller

1. A centrifugal fan comprising:
a main plate fixed to a rotating shaft of a drive unit;
a shroud including an air suction port; and
a plurality of blades disposed between the main plate and the shroud, wherein a rib is formed in each of the blades.

2. The centrifugal fan of claim 1, wherein the rib is formed so as to extend between a surface on which the shroud is in contact with each of the blades and a surface on which the main plate is in contact with each of the blades.

3. The centrifugal fan of claim 1, wherein the height of the rib is partially varied.

4. The centrifugal fan of claim 1, wherein the thickness of the rib is partially varied.

5. The centrifugal fan of claim 1, wherein each of the blades includes a main blade fixed to the main plate and the shroud, and a blade cover that is assembled with the main blade so as to have an internal space between the blade cover and the main blade and thereby forms each of the blades.

6. The centrifugal fan of claim 5, wherein the main blade includes a protruding portion that is fitted in a recessed portion formed in the shroud and whose top surface serves as a contact surface to be in contact with the shroud, and the rib is formed in the space so as to be continuous with a side wall surface of the protruding portion.

7. The centrifugal fan of claim 5, wherein the rib is formed in a shape which prevents the main blade and the blade cover from deforming toward the space.

8. The centrifugal fan of claim 7, wherein the rib is formed at a height corresponding to a shape of the blade cover.

9. The centrifugal fan of claim 1, wherein the blades have a twisted three-dimensional shape.

10. An air-conditioning apparatus comprising a centrifugal fan, the centrifugal fan comprising:
a main plate fixed to a rotating shaft of a drive unit;
a shroud including an air suction port; and
a plurality of blades disposed between the main plate and the shroud,
wherein a rib is formed in each of the blades.
